(19) United States
(12) Patent Application Publication
(10) Pub. No.: US 2021/0049489 A1
(43) Pub. Date: Feb. 18, 2021

(54) PROVIDING SOLUTIONS USING STOCHASTIC MODELLING

(71) Applicant: Hewlett-Packard Development Company, L.P., Spring, TX (US)

(72) Inventors: Shameed Sait M A, Bangalore (IN); Shafiuddin Rehan Ahmed, Bangalore (IN); Niranjan Damera Venkata, Chennai (IN)

(73) Assignee: Hewlett-Packard Development Company, L.P., Spring, TX (US)

(21) Appl. No.: 16/980,033

(22) PCT Filed: Aug. 14, 2018
(86) PCT No.: PCT/US2018/046653

§ 371 Date: Sep. 11, 2020

(30) Foreign Application Priority Data
Apr. 30, 2018 (IN) 201841016317

(51) Int. Cl. G06N 5/04; G06N 5/02; G06N 3/04; G06F 11/07

(52) U.S. Cl. CPC G06N 5/045; G06F 11/079; G06N 3/0472; G06N 5/022

(57) ABSTRACT

The present subject matter relates to example to provide solutions using stochastic modelling. In one example, a plurality case logs corresponding to an issue may be analyzed to identify a plurality of resolution steps. In addition, a relationship between each of the plurality of resolution steps may be identified from the plurality of case logs to generate a knowledge representation. In one example, a relationship between resolution steps is determined using a stochastic modelling technique. Further, based on the knowledge representation, a primary solution for the issue may be generated to resolve the issue.

### BACKGROUND

Customer support systems are employed to assist a customer care agent in resolving an issue raised by a user in a query. Such customer support systems provide the customer care agent with a database that may include manuals for resolving a wide variety of pre-identified issues. A manual may be a record of standard resolution steps to be taken to provide solution for the issue. The manuals are used by the customer care agent to guide the user through a series of step to provide solution for the issue.

### BRIEF DESCRIPTION OF FIGURES

The detailed description is provided with reference to the accompanying figures, wherein:

FIG. 1 illustrates an example of a network environment employing a system for resolving an issue;

FIG. 2 illustrates an example of the system for resolving an issue;

FIG. 3 illustrates a detailed schematic of the system for resolving an issue, according to an example;

FIG. 4 illustrates a knowledge representation, according to an example;

FIG. 5 illustrates a method for providing a solution for an issue, in according to an example.

FIG. 6 illustrates an example of a non-transitory computer readable medium for providing a solution for an issue.

It should be noted that the description and the figures are merely examples of the present subject matter and are not meant to represent the subject matter itself. Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or examples consistent with the description; however, the description is not limited to the examples and/or examples provided in the drawings.

### DETAILED DESCRIPTION

The customer support system may assist the customer care agent to resolve to the issue. For the customer care agent to provide solution for the issue, the customer care agent may identify the issue from the query, and thereafter, may feed the issue related query into the customer support system. In response, the customer support system may return a manual corresponding to the issue which the customer care agent may manually interpret to guide the user as to how the issue can be resolved. In addition, the customer care agent may create case logs to record the activities performed for resolving the issue, including new resolution steps undertaken by the customer care agent to provide solution for the issue. Such case logs are used in future, as reference, to resolve similar issues.

The current customer support systems may assist the customer care agents in the resolving different issues. However, the customer support system may not get updated with new resolution steps employed by the customer care agents. In other words, the database that the customer support system relies on is static and provide the standard resolution step. As a result, the customer support system may not be efficient in providing the resolution. Moreover, in response to the query, the customer support system may provide one or more manuals to the customer care agent, and the customer care agent may have to interpret the manual, identify the resolution steps, and guide the user to provide solution for the issue. The customer support system may not provide any guidance to the customer care agent in providing an appropriate resolution for the issue. Since, the customer care agent manually identifies the resolution, time taken to provide solution for the issue may be generally longer. This may further lead to the pendency at the customer support system as the time taken per issue is longer and other customers may have to wait for their call to be answered. Thus, the customer support system is not efficient. As a result, the customer support system may not be capable of providing resolution for the issues to multiple users.

The present subject matter relates to techniques for expanding the capabilities of customer support systems and assisting a customer care agent in resolving the issues of users, based on previously recorded resolution steps in the case logs and standard resolution steps. The present subject matter relates to techniques related to artificial intelligence that allows collection information from previously applied and recorded methodologies employed by the customer care agents. Further, based on the collected information, the artificial intelligence based techniques based of the present subject matter may also re-order the information in a manner to provide an appropriate solution for the issue. In addition, the artificial intelligence techniques based on the present subject matter may also provide an alternate solution in case previously provided resolution step is incapable to provide solution for the issue.

The technique based on the present subject matter operates in three steps. As a first step, a knowledge representation for each issue is created in terms of the relationships between resolution steps employed by the customer care agents. This is so done by analyzing case logs created by multiple customer care agents for that issue. Thereafter, as a second step, the resolution steps in the knowledge representation may be mapped with standard resolution steps existing in a library. Finally, as a third step, for a given issue, a list of resolution steps for providing appropriate resolution may be identified from the set of mapped and unmapped resolution steps in the knowledge representation.

According to an example, for each issue, as part of the first step, the knowledge representation may be prepared by performing analysis on multiple case logs corresponding to that issue. Further, case logs are a set of historically performed resolution steps employed and recorded as sentences by the customer care agent for the issue. In one example, for the analysis of the case log, the sentences may be parsed to identify resolution steps from the case logs. Once resolution steps are identified, the resolution steps that convey the same meaning are consolidated to obtain unique resolution steps. Once unique resolution steps are obtained, relationships between the unique resolution steps may be identified. Further, identification is based on a probability of occurrence of next resolution steps with respect to the previous resolution step. In one example, the relationship may be identified using various stochastic modelling techniques, such as Hidden Markov Model, Baum-Welch algorithm, expectation-maximization algorithm, or the like. Once the relationships between all the unique resolution steps are identified, a knowledge representation is generated.

Further, as part of the second step, the unique resolution steps in the knowledge representation may be mapped with a library of standard resolution steps corresponding to that issue. Standard resolution steps are pre-defined resolution step that are recorded in a standard manual or a product manual. In one example, mapping may be performed at three levels. At a first level, corresponding to each unique resolution step of the knowledge representation, a corresponding standard resolution step is searched in a standard resolution set for the specific issue and specific product. For the unique resolution steps in the knowledge representation corresponding to which the match is not found in the standard resolution set, a second level of search may be conducted against all other standard resolution sets included in the library for the specific product family. Thereafter, the unique resolution steps of the knowledge representation that still remain unmatched are searched at a third level in the library of the standard resolution steps that corresponds to all the issues and all the product families. Post conducting the mapping at the three levels, in few cases, there may be still unique resolution steps in the knowledge representation that remain unmapped. Such unique resolution steps may be mapped manually by an administrator.

Once the resolution steps are mapped, as the third step, a list of resolution steps that may provide an appropriate resolution for the issue may be predicted based on the knowledge representation.

According to another aspect, a query from the user may be received that may be interpreted to identify an issue. Further, the query may be mapped with a pre-existing issue. Once the issue is identified, a knowledge representation corresponding to the identified issue, from a plurality of knowledge representation, is selected. Thereafter, a primary solution for the issue may be presented. In one example, the primary solution may include a list of resolution steps based on the knowledge representation may be presented in order of a probability of occurrence of next resolution step. Further, the predicted resolution steps may be delivered along with documentations, such as videos, images, or text, that corresponds to the mapped standard resolution step. Also, in cases where a match between the resolution step and the standard resolution step is not found, the predicted resolution step may still be presented without the link to the documentation. According to the illustrated aspect, the customer care agent may be guided through predicted resolution steps to provide solution for the issue. Also, in case a resolution step does not work, a new list of backup resolution steps may be generated and provided to the customer care agent. In another example, a list of predicted resolutions step may be presented directly to the user. In both the above examples, the new list is also referred to as a secondary solution for the issue.

The technique based on the present subject matter may enable identification and learning of new resolution steps based on the case logs. In addition, the knowledge representation may be continually gathering case logs and adding further resolution steps, allowing the knowledge representation to dynamically change and for dynamic learning. Moreover, the technique based on the present subject matter rely on both the case logs created by the customer care agents as well standard resolution steps to provide the resolution. As a result, the historical resolution steps from the case logs are added and employed to provide solution for the issue thereby improving the effectiveness in providing the appropriate resolution for the issue. Moreover, since the query of the user is interpreted to identify the issue, reliance on the customer care agent to identify the issue, is avoided. As a result, appropriate resolution may be provided. Moreover, since the step by step resolution step is provided, time consumed by a customer care agent to provide the appropriate resolution is reduced thereby reducing the pendency associated with the current customer care support system.

The above aspects are further described in conjunction with the figures, and in associated description below. It should be noted that the description and figures merely illustrate principles of the present subject matter. Therefore, various arrangements that encompass the principles of the present subject matter, although not explicitly described or shown herein, may be devised from the description and are included within its scope. Additionally, the word “coupled” is used throughout for clarity of the description and can include either a direct connection or an indirect connection.

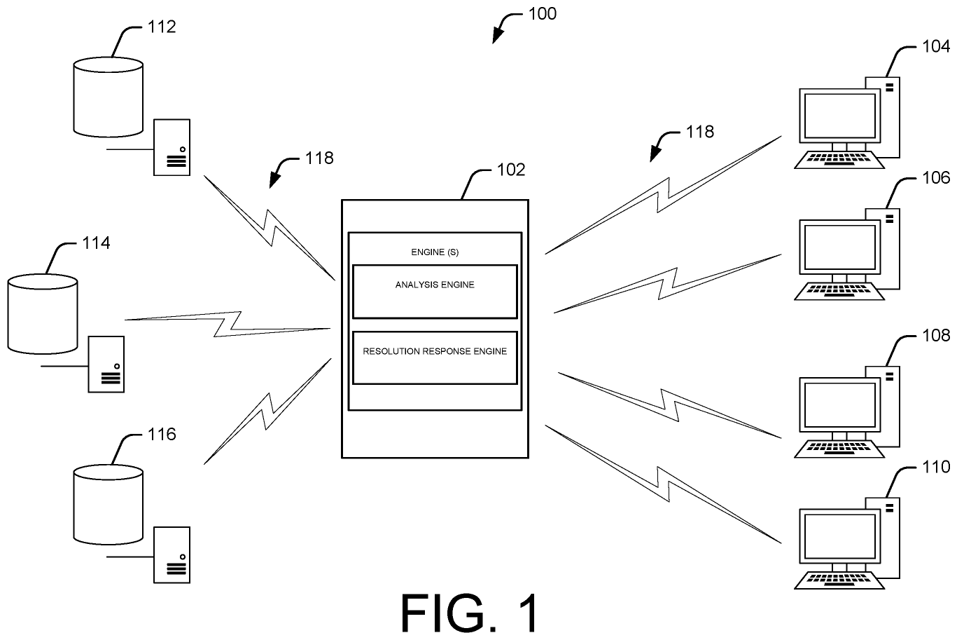

FIG. 1 illustrates a network environment 100 employing a system 102 for providing resolution to an issue by based on previously applied methodologies. For example, the system 102 may communicate with a user to receive a user query and provide a solution for the query by mapping the query to a pre-existing issue. In one example, the system 102 may update a knowledge base for each issue based on previously applied steps by the user. Thereafter, once the system 102 receives the query in real time, the system 102 may map the query with the issue, and accordingly, may provide a solution based on the updated knowledge base. The system 102 may be employed as any of a variety of conventional computing devices, including, servers, a desktop personal computer, a notebook or portable computer, a workstation, a mainframe computer, a mobile computing device, and a laptop. Further, in one example, the system 102 may itself be a distributed or centralized network system in which different computing devices may host one or more of the hardware or software components of the system 102.

The network environment 100 can further include a plurality of computing devices 104, 106, 108, 110 and a plurality of databases 112, 114, and 116 that are both in communicative connection with the system 102. As the system 102, the computing devices 104, 106, 108, 110 may be employed as any of a variety of conventional computing devices, including, servers, a desktop personal computer, a notebook or portable computer, a workstation, a mainframe computer, a mobile computing device, and a laptop. In another example, the various components of the computing devices 104, 106, 108, 110 may be employed as a part of a single computing device, for example, by virtualization.

The system 102 may be connected to the computing devices 104, 106, 108, 110 and the databases 112, 114, and 116 over a communication network 118 through one or more communication links. The communication links between the system 102, the computing devices 104, 106, 108, 110, and the databases are enabled through a desired form of communication, for example, via dial-up modem connections, cable links, digital subscriber lines (DSL), wireless or satellite links, or any other suitable form of communication.

The communication network 118 may be a wireless network, a wired network, or a combination thereof. The communication network 118 can also be an individual network or a collection of many such individual networks, interconnected with each other and functioning as a single large network, e.g., the Internet or an intranet. The communication network 118 can be employed as one of the different types of networks, such as intranet, local area network (LAN), wide area network (WAN), the internet, and such. The communication network 118 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. Further, the communication network 118 may include network devices, such as network switches, hubs, routers, for providing a link between the system 102 and the computing devices 104, 106, 108, and 110. The network devices within the communication network 118 may interact with the system 102 and the computing devices 104, 106, 108, and 110 through the communication links.

In operation, the system 102 can provide a solution to a query based on previously recorded case logs and library of standard resolution steps. The system 102 may operate in two stages. In first stage, the system 102 may analyze a set of case logs, for each issue, that were previously recorded by the user to identify the resolution steps. Thereafter, the system 102 may identify relationship between the resolution steps to generate a knowledge representation. In on example, the relationship may be identified based on a probability of occurrence of each subsequent resolution step. Further, the system 102 may generate separate knowledge representation for all the issue. The plurality of knowledge representations prepared by the system 102 may be used at a later stage to provide a solution for the issue.

As mentioned above, to facilitate the operation of the system 102 as mentioned above, the network environment 100 may include the databases to store various kinds of data. In one example, the network environment 100 may include a case log database 112 that may store case logs created by different users for resolving a variety of issues encountered in the past. The case log may be are the observations of all the historical resolution steps instructed by the user to the user for resolving the issue along with the record whether the resolution steps were executed by the user. The case log may also include an indication if any resolution step did not work. In one example, the case log database 112 may include a plurality of case logs for a wide variety of issues. In one example, the case log database 112 may be structured so that the case logs belonging to same issues are stacked together. Further, the system may include a library 114 that may store standard resolution steps for the plurality of issues. The network environment 100 may also include a knowledge representation database 116 that may store a plurality of knowledge representations generated by the system 102.

In the subsequent stage, the system 102 may receive a query entered by the user through one or more computing devices 104, 106, 108, and 110. In one example, the system 102 may interpret the query to identify the issue and thereafter, selects a knowledge representation from amongst the plurality of knowledge representation prepared during the first stage. Further, the system 102 may provide a primary solution for the issue in the form of an ordered list of resolution steps the user needs to perform to resolve the issue. Further, the list presented by the system 102 is based on a probability of occurrence of each subsequent resolution step. A manner by which the system resolves an issue will be explained in detail in subsequent examples.

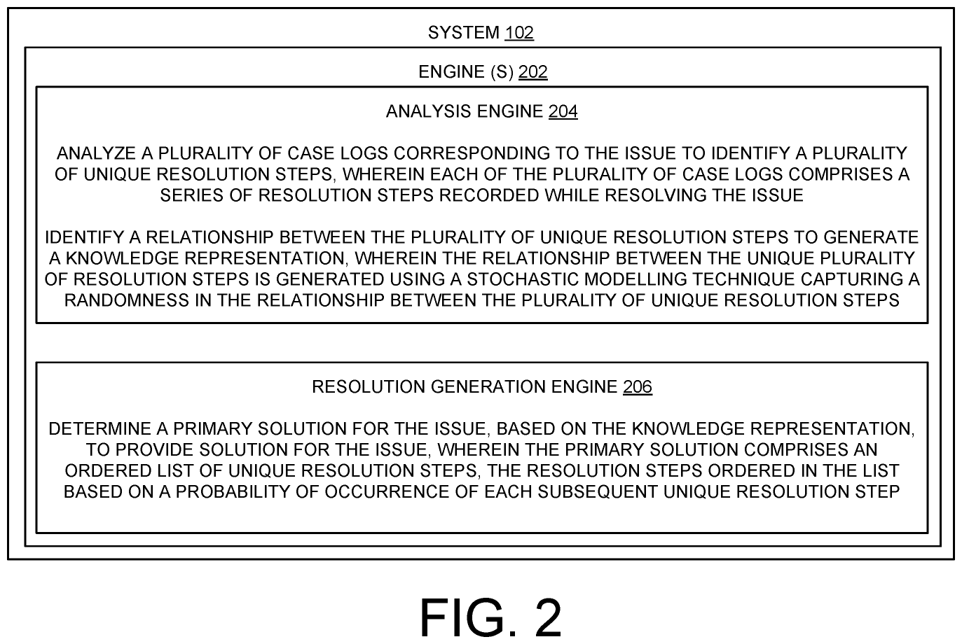

FIG. 2 illustrates a system 102 to provide a resolution for the issue, in accordance with one example of the present subject matter. The system 102 may include, for example, engines 202. The engines 202 are employed as a combination of hardware and programming (for example, programmable instructions) to use functionalities of the engines 202. In examples described herein, such combinations of hardware and programming may be used in a number of different ways. For example, the programming for the engines 202 may be processor executable instructions stored on a non-transitory machine-readable storage medium and the hardware for the engines 202 may include a processing resource (for example, processors), to execute such instructions. In the present examples, the machine-readable storage medium stores instructions that, when executed by the processing resource, deploy engines 202. In such examples, system 102 may include the machine-readable storage medium storing the instructions and the processing resource to execute the instructions, or the machine-readable storage medium may be separate but accessible to the 312 system 102 and the processing resource. In other examples, engines 202 may be deployed using electronic circuitry.

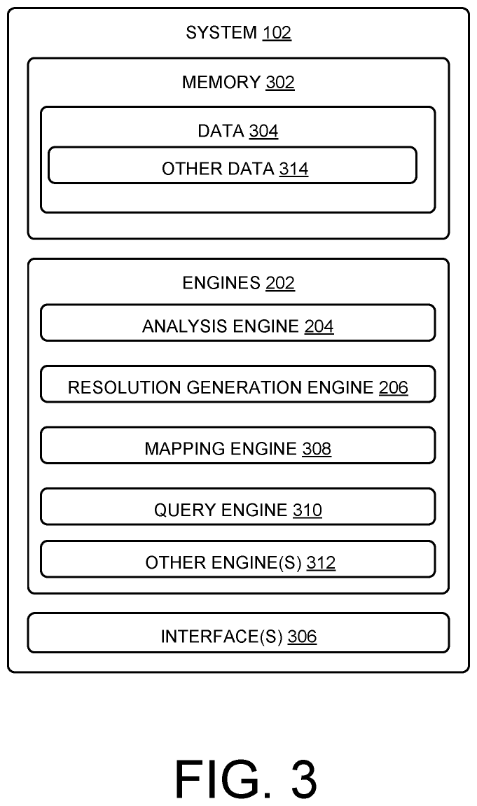

The engines 202 may include an analysis engine 204 and a resolution generation engine 206. In one example, the analysis engine 204 may analyze the plurality of case logs to identify a plurality of resolution steps. In one example, the analysis engine 204 may interpret the sentences in the case logs to identify a plurality of unique resolution steps. In addition, the analysis engine 204 may identify the unique resolution steps from the plurality of resolution steps based on the analysis. The analysis engine 204 may also determine a relationship between the identified unique resolution steps based on the plurality of case logs. The relationship between the plurality of identified resolution steps can be a sequence in which the resolution steps are recorded in the case logs. In one example, the relationship may be generated using a stochastic modelling technique capturing a randomness in the relationship between the plurality of unique resolution steps. The analysis engine 204 may also generate a knowledge representation based on the relationship between the plurality of identified resolution steps. The analysis engine 204 may generate a primary solution for the issue, based on the knowledge representation, to resolve the issue. The manner by which the system 102 operates will be explained with respect to FIG. 3 onwards.

FIG. 3 illustrates a detailed schematic of the system 102 to provide resolution for the issue showing various components of the system 102, according to an example of the present subject matter. The system 102, among other things and in addition to the engines 202, a memory 302 having data 304, and interface(s) 306. The engines 202, among other capabilities, may fetch and execute computer-readable instructions stored in the memory 302. The memory 302, communicatively coupled to the engines 202, may include a non-transitory computer-readable medium including, for example, volatile memory, such as Static Random Access Memory (SRAM) and Dynamic Random Access Memory (DRAM), and/or non-volatile memory, such as Read-Only-Memory (ROM), erasable programmable ROM, flash memories, hard disks, optical disks, and magnetic tapes.

In an example, in addition to the analysis engine 204 and the resolution generation engine 206, the engines 202 may include a mapping engine 308, a query engine 310, and other engine(s) 312. The other engine(s) 312 may provide functionalities that supplement applications or functions performed by the system 102.

Further, the data 304 includes data that is generated as a result of the functionalities carried out by any of the engines 202. The data 304 may include other data 314. The other data 314 may include data generated and saved by the engines 202 to provide various functionalities to the system 102.

As explained previously, in operation, the system 102 can operate in three steps. As a first step, the system 102 may create a knowledge representation for each issue in terms of the relationships between resolution steps employed by the customer care agents. This is so done by analyzing case logs created by multiple customer care agents for that issue. Thereafter, as a second step, the system may map the resolution steps in the knowledge representation with standard resolution steps existing in a library. Finally, as a third step, for a given issue, the system 102 may provide a primary solution that may include a list of resolution steps for providing appropriate resolution.

Accordingly, in an example, the analysis engine 204 may analyze the case logs in the case log database 112 to generate knowledge representation each for all the issues. In one example, the analysis engine 204 may receive a plurality of case logs, recorded for one type of issue, from the case log database 112 to identify the resolution step. As mentioned previously, each case log includes series of resolution steps recorded by the operator depicting the steps taken in past to resolve the issue. The analysis engine 204 may employ a stochastic modelling technique, such as Hidden Markov Modelling (HMM) technique. In one example, the analysis engine 204 may train HMM in order to generate the knowledge representation. An example by which the analysis engine 204 operates to generate knowledge representation is explained with respect to FIG. 3.

The analysis engine 204 may analyze the sentences in two steps. In the first step, the analysis engine 204 may identify the words in each sentence of the case logs, and in the second step may identify the sentence. In one example, as part of the first step, the analysis engine 204 parses the sentences to infer the meaning of each word. In addition, the analysis engine 204 may employ techniques, such as Word2Vec technique to infer a context in which the words are used. For example, a sentence in a case log ‘Customer instructed to connect the ethernet cable’ will be analyzed to identify word representations, such as, ‘customer’, ‘connect’, ‘ethernet cable’. Moreover, the analysis engine 204 also clusters the words together that conveys the same meaning. For example, terms like “customer”, “CU”, “CX”, “user” conveys the same meaning, i.e. customer. Accordingly, in an example, the system 102 clusters them as a single word so as to facilitate in identifying the resolution step.

In one example, once the analysis engine 204 identifies the words, the analysis engine 204 may analyze the sentences to determine the resolution steps that have been previously selected or recommended by user. The analysis engine 204 may also clean up grammar to identify the unique resolution step from the sentences. In one example, the analysis engine 204 employing HMM technique may identify the resolution steps as ‘hidden states’ from the sentences. Once the analysis engine 204 identifies hidden states to identify the resolution steps from the sentences, the analysis engine 204 may consolidate the resolution steps that convey the same meaning as the unique resolution step. In one example, one case log may have a resolution step recorded as ‘Customer instructed to switch OFF/ON the printer’ while another case log may have same resolution step recorded as ‘Customer advised to power cycle the printer’. Further, both the sentences relate to the unique resolution step of ‘restart the printer’.

The analysis engine 204 identifies and clusters such unique resolution steps together. The analysis engine 204 may consolidate similar resolution steps to better predict relationships between the unique resolution steps. In addition, the analysis engine 204 labels the consolidated resolution step for a unique resolution step with a representative. Such labels may provide same identifier for same unique resolution steps. The analysis engine 204 identifies and records the unique resolution step that have been successful in resolving the issue. The analysis engine 204 may also identify and record all the unique resolution steps that may not have led to resolution.

In one aspect, once similar resolution steps have been identified and consolidated, the analysis engine 204 may identify relationship between the unique resolution steps. The analysis engine 204 may employ a stochastic modelling technique, such as Hidden Markov Modelling (HMM) technique, Long Short-Term Memory technique, Convolution Neural Network technique, Recurrent Neural Network technique, or a combination of a plurality of techniques, to identify relationship between the unique resolution steps. In one example, the analysis engine 204 determines the sequence of the unique resolution steps and also determines a probability of transition from one unique resolution step to the next unique resolution step. The analysis engine 204 may identify the sequence to generate a knowledge representation. An example of the analysis engine 204 to determine the probabilities of transition using HMM technique is explained in subsequent paragraphs.

In one example, to determine the relationship, the analysis engine 204 may employ a stochastic technique, such as Baum-Welch technique, to compute a probability of transition from resolution steps. The Baum-Welch technique can be employed once to determine all probabilities of transitions. Since the Baum-Welch technique is a technique, a manner by which the Baum-Welch technique is employed to determine the probabilities of transition between the resolution steps is not explained in detail.

In one example, the analysis engine 204 may also normalize the probabilities of transition of resolution step in cases where the probability of transition between the resolution steps may be recurring or repeating. For example, there may be a case where the probability of transition from step s2 to s3 may be such that the resolution steps s3 and s2 becomes recurring with respect to each other. As a result, the analysis engine 204 using HMM technique may keep on computing the same probability in loop. In such cases, the analysis engine 204 may re-compute the probability of transition that the recurrence between the resolution steps is removed. Such technique may prevent looping in computing the probability of transition.

According to one aspect, the analysis engine 204 may employ other techniques in addition to the HMM to facilitate in identifying relationships between the unique resolution steps. For instance, in another case, the analysis engine 204 may employ Recurrent Neural Network (RNN) to determine relationship between the resolution steps. The sequence of resolutions step calculated using RNN technique is based on the occurrence of all previous resolution steps. Further, the RNN technique may be employed in addition to the HMM technique. An example of the analysis engine 204 to determine the sequence using RNN is explained in the next paragraph.

The analysis engine 204 may employ RNN technique after the analysis engine 204 has identified the resolution steps and probabilities of transition using HMM technique. The analysis engine 204 may employ the HMM technique to decode the case log to identify a sequence of resolution steps based on the sentences in the case log. The analysis engine 204 may perform decoding for all the case logs to identify all the sequence of resolution steps in all the case logs. Once the sequences are identified, the analysis engine 204 may employ the RNN technique to learn the transition of resolution steps based on sequences of resolution steps. In one example, the analysis engine 204 may capture a pattern of transitions of resolution steps that occurs in the case log. Thereafter, the analysis engine 204, given a sequence of resolution steps, the analysis engine 204 may predict a probability of transition of a resolution step based on the occurrence of previous resolution steps in the sequence. Since the RNN technique is a technique, a manner by which the RNN identifies the sequence is not explained for the sake of brevity. Additionally, the analysis engine 204 may incorporate additional details, referred to as supplementary information, in addition to information present in case logs to predict the sequence of resolution steps. For example, the supplementary information can be regional information, or product or model related information that may or may not present in the case logs but may be useful in predicting the sequence of unique resolution steps. In other example, the supplementary information may be available from the case logs, such as an indication if the resolution step may have led to a successful resolution or not. Such supplementary information may be factored by the analysis engine 204 by feeding the information to the RNN technique to determine the resolution steps. A manner by which the supplementary information may be incorporated is known in the art.

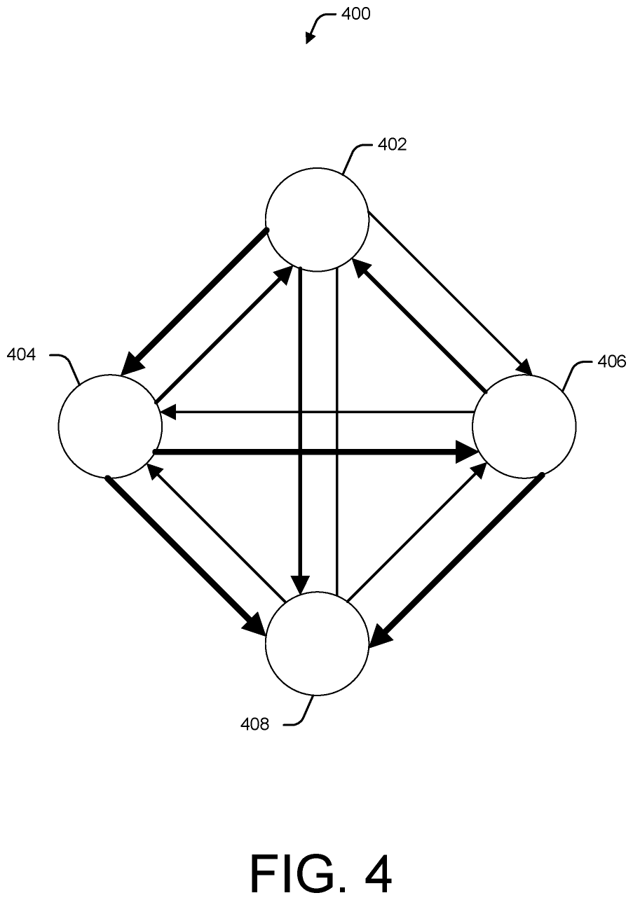

The probability of transition computed above may be used to generate a knowledge representation. In one example, the probabilities calculated either using HMM may be depicted as a graph of resolution steps connected by nodes and their probability of transition is depicted as connector between nodes. An example of a knowledge representation 400 may be explained with respect to FIG. 4.

FIG. 4 illustrates a knowledge representation 400 of the based on the calculated probabilities between the resolution. Although the knowledge representation 400 is depicting relationship between four unique resolution steps, the knowledge representation 400 may include multiple unique resolution steps. In the illustrated example, each node 402, 404, 406, and 408 in the knowledge representation 400 represents the unique resolution step. Further, connectors connecting the nodes 402, 404, 406, 408 represents probabilities of transition from one of the unique resolution step to other unique resolution step. In one example, a thickness of the connector is based on a based a value of the calculated probability either through the HMM technique. For example, higher probability is represented with thicker line where lower probability is represented with a thinner line. Such representation may facilitate in visualizing the relationship between the unique resolution steps. Further, the knowledge representation 400 may be stored in the knowledge representation database 116 (shown in FIG. 1). Although single knowledge representation 400 is shown, other knowledge representations for different issues may be generated and stored in the knowledge representation database 116. Once the knowledge representation 400 are generated, the unique resolution step may be mapped to the standard resolution steps.

Referring back to FIG. 3, the mapping engine 308 may map all the unique resolution steps in the knowledge representation with the standard resolution steps recorded for the issue. In one example, the mapping engine 308 may associate the unique resolution steps with a corresponding standard resolution step. As mentioned before, in an example, the library 114 may include the standard resolution steps, in the form of manuals, for all issue and for the all the product/service for which the system 102 provides resolution.

In one example, the mapping engine 308 map the unique resolution steps and the standard resolution steps at three levels. At a first level, the mapping engine 308 may fetch a manual from the library 114 that corresponds to the specific issue and for the specific product. Once the manual is fetched, the mapping engine 308 selects one unique resolution step from the knowledge representation and searches for a corresponding standard resolution step in the library. In one example, the mapping engine 308 may employ techniques, like Word2Vec for the mapping. In one example, the mapping engine 308 may parse each resolution step and may assign a vector to each word in the resolution step. Once each word is assigned a vector, the mapping engine 308 may compute a vector for the resolution step by computing an average of the vectors of the words in the resolution step. Thereafter, the mapping engine 308 may compare the computed vector with pre-defined vectors for the standard resolutions steps. In one example, the mapping engine 308 may employ cosine similarity technique to find a match between the vector of the resolution step and the pre-defined vectors of the standard resolution steps to identify the standard resolution step. Once the mapping engine 308 finds the corresponding standard resolution step, the mapping engine 308 may associate a documentation, corresponding to the identified unique resolution step, with the unique resolution step whose mapping is being done. This mapping is performed for each unique resolution step in the knowledge representation. There may be a case where some of the unique resolution steps may not be mapped. The unmapped unique resolution steps may be mapped at a second level.

At the second level, the mapping engine 308 may fetch manuals for the all the issue pertaining to the product family. Further, the mapping engine 308 select one unmapped unique resolution step and employ Word2Vec technique to identify a corresponding standard resolution step in the fetched manuals and once the mapping engine 308 finds a matching standard resolution step, the mapping engine 308 may associate a documentation, corresponding to matched standard resolution step, the unmatched unique resolution step may. The mapping engine 308 may conduct the same activity for all the unmatched unique resolution step. Once the second level mapping is completed, the unique resolution step that are still unmatched may be at the third level.

At the third level, the mapping engine 308 may fetch the manual that corresponds to all the issues and all the product families from the library 114. At the third level, the mapping engine 308 may perform the technique as explained before and the unique resolution steps that are still unmapped are mapped. There may be a case where one or more resolution may still be left unmatched after three levels of mapping. The left out unmatched unique resolution steps may then be matched manually by an administrator. Once the mapping is performed, the knowledge representations may be used to provide a resolution. A manner by which the system 102 provides resolution is explained in detail in the subsequent example.

Once the system 102 is prepared in the manner explained above, the system 102 may cater to queries and provide appropriate solutions to the queries, in accordance with the present subject matter. Accordingly, in an aspect, the query engine 310 may receive a query from a user. The query engine 310, for instance, may receive the query from one or more computing devices 104, 106, 108, 110. Once the query engine 310 receives the query, the query engine 310 may identify an issue from the query. The query engine 310 may parse the query to identify the query and identify the issue that the query is associated to the issue. In one example, the query engine 310 may perform parsing of the query using techniques, such as Word2Vec. In one example, the query engine 310 may parse the query to identify the words and assign a vector to each query. Thereafter, the query engine 310 may compute a vector for the query by computing an average of the assigned vectors of each word in the query. Once the query engine 310 obtains a vector for the query, the query engine 310 may compare the vector with pre-calculated vector based on sample queries. The sample queries are the queries related to pre-defined issues. Once the query engine 310 find a match with a corresponding sample query, the query engine 310 may identify the issue. Once the query engine 310 identifies the issue, the resolution generation engine 206 may search for a knowledge representation in the knowledge representation database 116 that corresponds to the identified issue. In one example, the resolution generation engine 206 may search for a knowledge representation that corresponds to the issue identified from the query. Once the resolution generation engine 206 identifies the knowledge representation that corresponds to the issue, the resolution generation engine 206 fetches the identified knowledge representation. Further, the resolution generation engine 206 may provide a primary solution for the issue in form a list of unique resolution step from the in response to the query based on the computed probabilities of transition.

In one example, the resolution generation engine 206 may provide the list of unique resolution steps. Thereafter, the resolution generation engine 206 presents the list of unique resolution steps in order of higher probabilities of transition. In addition, the query engine 310 may provide the documentation associated with unique resolution step. In an example, based on the resolution steps provided in the list, the user may navigate through the list of unique resolution step. In one example, the user may select a unique resolution step which is on top of the list. According to the selection, the query engine 310 may provide the documentation, if available, associated with the unique resolution step to instruct the user to perform the unique resolution step. The documentation may include video or audio or images to guide the user to perform the unique resolution steps.

The resolution generation engine 206 may then wait for a feedback from the user to confirm if the unique resolution step was successfully performed. Once the resolution generation engine 206 receives a confirmation that the unique resolution step is successfully performed, the resolution generation engine 206 may provide the next unique resolution step based on the highest value of probabilities of transition from the previously performed unique resolution step. The resolution generation engine 206 may also provide a documentation, if available, along with the next unique resolution step. This process is repeated until the issue is resolved.

There may be a case where one of the unique resolution step may not be performed by the user or the user may report that the user is unable to perform the unique resolution step or that the unique resolution step is inapplicable, the resolution generation engine 206 may generate a new list of unique resolution step, also referred to as a secondary solution for the issue based on the knowledge representation. In one example, the resolution generation engine 206 may start from the last unique resolution step that has been successfully performed and completed by the user. Thereafter, in an example, the resolution generation engine 206 may check for the probabilities of transition to other unique resolution step from the last unique resolution step. Accordingly, the resolution generation engine 206 may select the unique resolution steps that have higher probabilities of transition with respect to the last successfully performed unique resolution step. Further, the resolution generation engine 206 may present the selected unique resolution steps as a new list in order of higher probabilities of transition. In other example, the resolution generation engine 206 may provide an alternate unique resolution step, again, also referred to as the secondary solution for the issue, from amongst the list of resolution steps as a replacement for a previously provided unique resolution step that is incapable of providing the solution for the issue or that the user is unable to perform. Thereafter, the user may be instructed to continue performing the unique resolution steps in the list until the issue is resolved.

The operation for providing the resolution for the query may be recorded in a case log and the same case log is stored in the case log database 112. The case log may then be analyzed by the analysis engine 204 as mentioned above to update the knowledge representation. As a result, the system 102 may constantly learn in parallel.

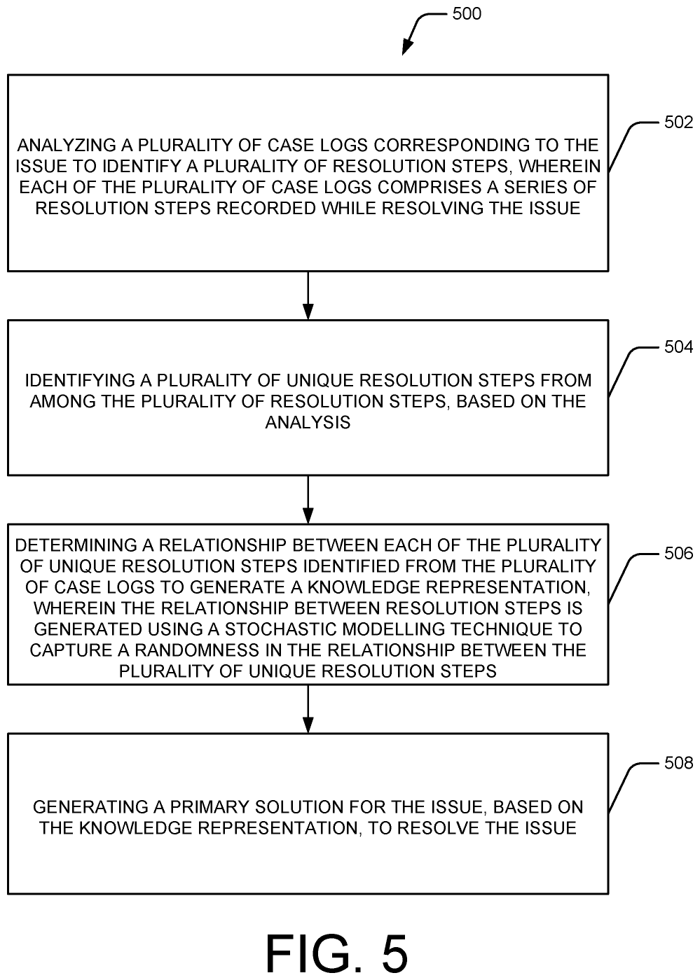

FIG. 5 illustrates a method 500 for providing the resolution for the issue according to an example of the present subject matter. The method(s) may be described in the general context of computer executable instructions. Generally, computer executable instructions can include routines, programs, objects, components, data structures, procedures, engines, functions, etc., that perform particular functions or employ particular abstract data types. The method may also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to employ the method 500, or an alternative method. Additionally, individual blocks may be deleted from the methods without departing from the spirit and scope of the subject matter described herein. Furthermore, the methods 500 can be employed in any suitable hardware, software, firmware, or combination thereof. The methods 500 is explained with reference to the system 102, however, the methods can be employed in other systems as well.

Referring to method 500, at block 502, the plurality case logs corresponding to an issue may be analyzed to identify a plurality of resolution steps, In one example, each of the plurality of case logs comprises a series of resolution steps recorded while resolving the issue.

At block 504, once the resolution steps are identified, a plurality of unique resolution steps from among the plurality of case logs, based on the analysis at block 502. Once unique resolution steps are identified, the method moves to the next block.

At block 506, a relationship between each of the plurality of unique resolution steps may be identified from the plurality of case logs to generate a knowledge representation. In one example, the relationships between resolution steps is generated using a stochastic modelling technique capturing a randomness in the relationships between the plurality of unique resolution steps.

At block 508, a primary solution for the issue, based on the knowledge representation, to resolve the issue may be generated. In an example, the primary solution can include an ordered list of unique resolution steps and the resolution steps in the primary solution are ordered in the list, based on a probability of occurrence of each subsequent unique resolution step. In other words, in said example, the probability of occurrence of one resolution step in subsequence of the previous resolution step can be the basis for ordering the unique resolution steps in the list in the primary solution.

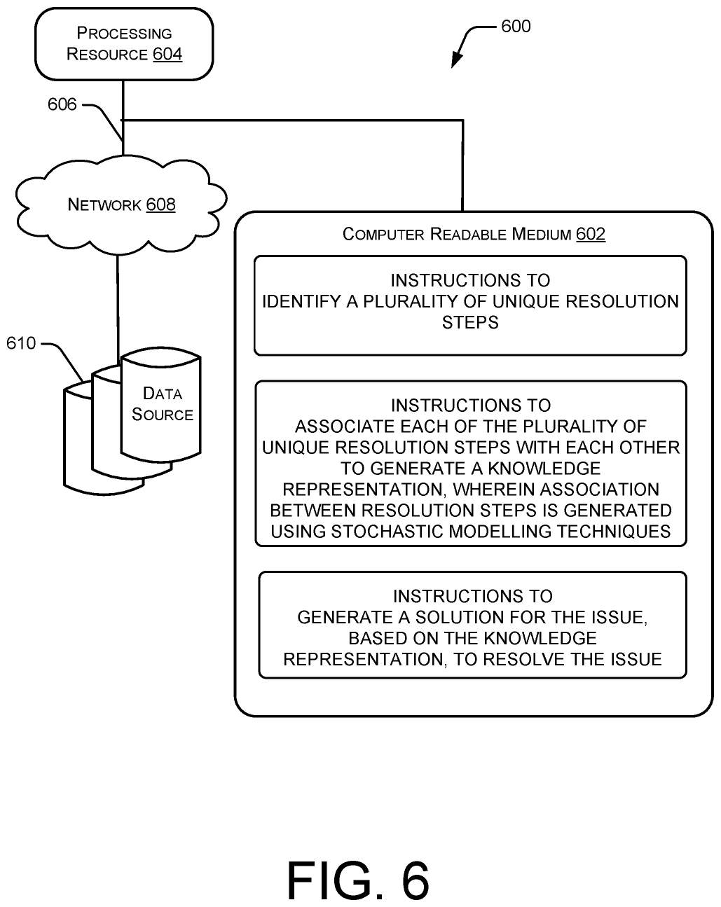

FIG. 6 illustrates an example network environment 600 using a non-transitory computer readable medium 602 to resolve the issue, according to an example of the present subject matter. The network environment 600 may be a public networking environment or a private networking environment. In one example, the network environment 600 includes a processing resource 604 communicatively coupled to the non-transitory computer readable medium 602 through a communication link 606.

For example, the processing resource 604 may be a processor of a computing system, such as the system 102. The non-transitory computer readable medium 602 may be, for example, an internal memory device or an external memory device. In one example, the communication link 606 may be a direct communication link, such as one formed through a memory read/write interface. In another example, the communication link 606 may be an indirect communication link, such as one formed through a network interface. In such a case, the processing resource 604 may access the non-transitory computer readable medium 602 through a network 608. The network 608 may be a single network or a combination of multiple networks and may use a variety of communication protocols.

The processing resource 604 and the non-transitory computer readable medium 602 may also be communicatively coupled to data sources 610 over the network 608. The data sources 610 may include, for example, databases and computing devices. The data sources 610 may be used by the database administrators and other users to communicate with the processing resource 604.

In one example, the non-transitory computer readable medium 602 includes a set of computer readable and executable instructions, such as the analysis engine 204. The set of computer readable instructions, referred to as instructions hereinafter, may be accessed by the processing resource 604 through the communication link 606 and subsequently executed to perform acts for network service insertion.

For discussion purposes, the execution of the instructions by the processing resource 604 has been described with reference to various components introduced earlier with reference to description of FIG. 3.

On execution by the processing resource 604, the analysis engine 204 may identify a plurality of unique resolution steps from amongst a plurality of resolution steps previously employed for providing solution to the issue. In addition, the analysis engine 204 may associate each of the plurality of unique resolution steps with each other to generate a knowledge representation. In said example, the analysis engine 204 may associate the resolution steps with each other, and generate the representation using stochastic modelling techniques. For instance, the stochastic modelling techniques Hidden Markov Model (HMM) technique and other techniques as mentioned previously may be used. Further, the analysis engine 204 may generate a primary solution for the issue, based on the knowledge representation, to resolve the issue.

Although aspects for methods and systems for resolving issues have been described in a language specific to structural features and/or methods, the invention is not necessarily limited to the specific features or methods described. Rather, the specific features and methods are disclosed as examples for resolving the issue.

What is claimed is:

1. A method of providing solution for an issue, the method comprising:
analyzing a plurality of case logs corresponding to the issue to identify a plurality of resolution steps, wherein each of the plurality of case logs comprises a series of resolution steps recorded while resolving the issue;
identifying a plurality of unique resolution steps from among the plurality of resolution steps, based on the analysis;
determining a relationship between each of the plurality of unique resolution steps identified from the plurality of case logs to generate a knowledge representation, wherein the relationship between resolution steps is generated using a stochastic modelling technique to capture a randomness in the relationship between the plurality of unique resolution steps; and
generating a primary solution for the issue, based on the knowledge representation, to resolve the issue.

2. The method as claimed in claim 1, wherein the relationship is determined using one of Hidden Markov Model, Baum-Welch technique, Expectation-Maximization technique, and Recurrent Neural Network technique.

3. The method as claimed in claim 1 further comprising mapping the plurality of unique resolution steps in the knowledge representation with standard resolution steps recorded for the issue.

4. The method as claimed in claim 1, wherein the analyzing comprises parsing the plurality of case logs to identify the plurality of resolution steps.

5. The method as claimed in claim 1, wherein the generating the primary solution comprises ordering a list of unique resolution step based on a probability of occurrence of next resolution step.

6. The method as claimed in claim 1 further comprising:
interpreting a query from a user to map the query to the issue; and
identifying a knowledge representation corresponding to the issue from amongst a plurality of knowledge representations.

7. The method as claimed in claim 6 further comprising predicting a new list of resolution steps based on the knowledge representation when a resolution step from the primary solution is incapable to provide solution for the issue.

8. The method as claimed in claim 6 further comprising predicting an alternate resolution steps for a resolution step in the primary solution, when a resolution step from the primary solution is incapable to provide solution for the issue.

9. A system to provide solution to an issue, the system comprising
an analysis engine to:
analyze a plurality of case logs corresponding to the issue to identify a plurality of unique resolution steps, wherein each of the plurality of case logs comprises a series of resolution steps recorded while resolving the issue;
identify a relationship between the plurality of unique resolution steps to generate a knowledge representation, wherein the relationship between the unique plurality of resolution steps is generated using a stochastic modelling technique capturing a randomness in the relationship between the plurality of unique resolution steps; and
a resolution generation engine to:
determine a primary solution for the issue, based on the knowledge representation, to provide solution for the issue, wherein the primary solution comprises an ordered list of unique resolution steps, the resolution steps ordered in the list based on a probability of occurrence of each subsequent unique resolution step.

10. The system as claimed in claim 9, wherein the analysis engine is to consolidate similar resolution steps to each of the plurality of unique resolution steps, and wherein the analysis engine is to assign a representative to the consolidated resolution steps.

11. The system as claimed in claim 9 further comprising a mapping engine to map each resolution steps with a corresponding standard resolution steps stored in a library.

12. The system as claimed in claim 9 further comprising a query engine to receive a query of a user, wherein the query engine is to parse the query to interpret the query and identify the issue that the query is associated to.

13. The system as claimed in claim 9, wherein the resolution generation engine is to predict the resolution step based on supplementary information, the supplementary information being in addition to information present in case logs.

14. A non-transitory computer-readable medium comprising computer-readable instructions providing solution for an issue, which, when executed by a processing resource, cause the processing resource to:
identify a plurality of unique resolution steps from amongst a plurality of resolution steps previously employed for providing solution to the issue;
associate each of the plurality of unique resolution steps with each other to generate a knowledge representation, wherein association between resolution steps is generated using stochastic modelling techniques; and
generate a solution for the issue, based on the knowledge representation, to resolve the issue.

15. The non-transitory computer-readable medium as claimed in claim 14 further comprising instructions executable by the processing resource to map the unique resolution steps in the knowledge representation with standard resolution steps recorded for the issue.
